(19) United States
(12) Patent Application Publication
(10) Pub. No.: US 2025/0175892 A1
(43) Pub. Date: May 29, 2025

(54) NON-NETWORK-SLICING-BASED CONFIGURATION METHOD, DEVICE AND NON-TRANSITORY COMPUTER-READABLE MEDIA

(71) Applicant: LITE-ON TECHNOLOGY CORPORATION, TAIPEI CITY (TW)

(72) Inventor: Sheng Heng YAN, TAIPEI CITY (TW)

(21) Appl. No.: 18/952,151

(22) Filed: Nov. 19, 2024

Related U.S. Application Data
(60) Provisional application No. 63/603,146, filed on Nov. 28, 2023.

(30) Foreign Application Priority Data
Sep. 5, 2024 (TW) 113133648

(51) Int. Cl. H04W 48/18; H04W 48/08; H04W 60/00

(52) U.S. Cl. CPC H04W 48/18; H04W 48/08; H04W 60/00

(57) ABSTRACT

A non-network-slicing-based configuration method is provided. The method includes generating, by a next-generation radio access network (NG-RAN) node, a next-generation setup request message, wherein the next-generation setup request message does not include a first network slice support list supported by the NG-RAN node. The method includes transmitting, by the NG-RAN node, the next-generation setup request message to an access and mobility management function (AMF) node in a core network.

### CROSS REFERENCE TO RELATED APPLICATIONS

This application claims the benefit of U.S. Provisional Application No. 63/603,146, entitled “5G RAN Configuration”, filed on Nov. 28, 2023, the entirety of which is incorporated by reference herein.

This application claims priority of Taiwan Patent Application No. 113133648, filed on Sep. 5, 2024, the entirety of which is incorporated by reference herein.

### BACKGROUND OF THE INVENTION

### Field of the Invention

The present disclosure generally relates to mobile network technology. More specifically, aspects of the present disclosure relate to a non-network-slicing-based configuration method, device, and non-transitory computer readable medium used in a next-generation radio access network (NG-RAN) node of a fifth generation (5G) mobile or cellular communication system.

### Description of the Related Art

Compared with the 4G mobile communication network, the 5G mobile communication network not only improves the transmission rate and reduces the delay, but also explores and standardizes more different application scenarios.

Starting from 3GPP version 15, network slicing has also become one of the main specifications of 5G mobile communication networks.

A network slice selection function (NSSF) is a function independent from an access and mobility management function (AMF) node, and can select a group of slice instances for user equipment (UE) when the UE initially accesses a network.

In Section 8.7.1.2 of 3GPP TS 23.786, the following content is mentioned: the NG-RAN node starts the NG setup procedure by sending an NG SETUP REQUEST message containing appropriate data to the AMF node. The AMF node responds with an NG SETUP RESPONSE message containing the appropriate data.

The NG CONFIGURATION REQUEST message is specified in Section 9.2.6.1 of 3GPP TS 23.786, wherein the slice support list is marked as mandatory. The NG CONFIGURATION RESPONSE message is specified in Section 9.2.6.2 of 3GPP TS 23.786, wherein the slice support list is marked as mandatory. In other words, the slice support list should always be included in the NG CONFIGURATION REQUEST message and the NG CONFIGURATION RESPONSE message.

When the AMF node does not support the slice support list sent by the NG-RAN node, the AMF node sends a NG SETUP FAILURE message to the NG-RAN node to indicate the NG SETUP failure. Thus, the NG-RAN node and AMF node cannot successfully establish a connection.

Under the current 5G system architecture, in addition to setting the 5G Quality-of-Service (QoS) Identifier (5QI) list during the Initial Context Setup process, the NG-RAN node also needs to set the network slice support list. This may lead to the following disadvantages. (1) Since settings in the base station are less flexible, the 5QI list and the network slice support list need to be set during deployment of the base station. Therefore, the application scenarios supported by the base station cannot be changed at will. (2) Even though the capability of the base station is sufficient to support the application's transmission rate, QoS, etc., the base station may not be used under this network slice because the settings of the network slice are inconsistent. (3) Even though the base station has set up a network slice, the base station may not be able to provide the services required by the UE under the network slice when the base station's capabilities or 5QI list are incorrect or not supported.

Therefore, a non-network-slicing-based configuration method, device and non-transitory computer-readable medium are needed to solve the above problems.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a non-network-slicing-based configuration method, device and non-transitory computer-readable medium. The RAN node does not need to configure information about the network slice, and the next-generation setup request message sent by the RAN node to the AMF node does not need to include a network slice support list, so as to increase the flexibility in the deployment of RAN nodes and simplify the parameter settings of the RAN nodes and the communication process with the AMF.

In an exemplary embodiment, a non-network-slicing-based configuration method is provided. The method comprises generating, by a next-generation radio access network (NG-RAN) node, a next-generation setup request message, wherein the next-generation setup request message does not include a first network slice support list supported by the NG-RAN node. The method comprises transmitting, by the NG-RAN node, the next-generation setup request message to an access and mobility management function (AMF) node in a core network.

In some embodiments, the next-generation setup request message includes a Quality-of-Service (QoS) flow setup request list supported by the NG-RAN node.

In some embodiments, the method further comprises receiving, by the NG-RAN node, a next-generation setup response message from the AMF node, wherein the next-generation configuration response message does not include a second network slice support list supported by the core network.

In some embodiments, the next-generation setup response message includes a Quality-of-Service (QoS) flow for each transport network layer (TNL) information item of application services required by the AMF node.

In an exemplary embodiment, a non-network-slicing-based configuration device is provided. The non-network-slicing-based configuration device comprises radio front-end circuitry and processor circuitry. The radio front-end circuitry is configured to perform wireless communication over a wireless network. The processor circuitry is coupled to the radio front-end circuitry and is configured to generate a next-generation setup request message, wherein the next-generation setup request message does not include a first network slice support list supported by the device. The processor circuitry is further configured to transmit, using the radio front-end circuitry, the next-generation setup request message to an access and mobility management function (AMF) node in a core network.

In an exemplary embodiment, a non-transitory computer readable medium having instructions stored thereon that, when executed by one or more processors of a next-generation radio access network (NG-RAN) node, cause the NG-RAN node to perform operations. The operations comprise generating a next-generation setup request message by a next-generation radio access network (NG-RAN) node, wherein the next-generation setup request message does not include a first network slice support list supported by the NG-RAN node. The operations comprise transmitting the next-generation setup request message to an access and mobility management function (AMF) node in a core network by the NG-RAN node.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a schematic diagram of a network architecture according to an embodiment of the present disclosure.

FIG. 2 is a flowchart showing a non-network-slicing-based configuration method according to an embodiment of the present disclosure.

FIG. 3 is a schematic flowchart of the next-generation setup procedure between the NG-RAN node and the AMF node according to an embodiment of the present disclosure.

FIG. 4 illustrates an example of infrastructure equipment 400 in accordance with various embodiments of the present disclosure.

FIG. 5 illustrates exemplary components of baseband circuitry and radio front-end modules (RFEM) in accordance with various embodiments of the present disclosure.

FIG. 6 depicts a block diagram illustrating components, according to some example embodiments, able to read instructions from a machine-readable or computer-readable medium (e.g., a non-transitory machine-readable storage medium) and perform any one or more of the methodologies discussed herein.

### DETAILED DESCRIPTION OF THE INVENTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

The technical solutions provided in the present disclosure may be applied to various communication systems. In a communication system, a part operated by an operator may be referred to as a public land mobile network (PLMN) (which may also be referred to as an operator network or the like). The PLMN is a network established and operated by a government or an operator approved by the government to provide a land mobile communication service for the public, and is mainly a public network in which a mobile network operator (MNO) provides a mobile broadband access service for a user. The PLMN described in the present disclosure may be specifically a network compliant with a specification of the 3rd generation partnership project (3GPP), which is referred to as a 3GPP network for short. The 3GPP network usually includes but is not limited to a 5th generation (5G) network (5G network for short), a 4th generation (4G) network (4G network for short), and the like. For ease of description, the PLMN is used as an example for description in embodiments of the present disclosure. Alternatively, the technical solutions provided in the present disclosure may be further applied to a long term evolution (LTE) system, an LTE frequency division duplex (FDD) system, an LTE time division duplex (TDD) system, an universal mobile telecommunications system (UMTS), a worldwide interoperability for microwave access (WiMAX) communication system, a 5th generation (5G) communication system, a new radio (NR) communication system, or another future communication system such as 6G.

With expansion of the mobile bandwidth access service, mobile networks are developing to better support diversified business models and meet requirements of more diversified application services and industries. For example, to provide better and more comprehensive services for more industries, a network architecture is adjusted for the 5G network compared with that of the 4G network. For example, the 5G network splits a mobility management entity (MME) in the 4G network into a plurality of network functions including an access and mobility management function (AMF), a session management function (SMF), and the like.

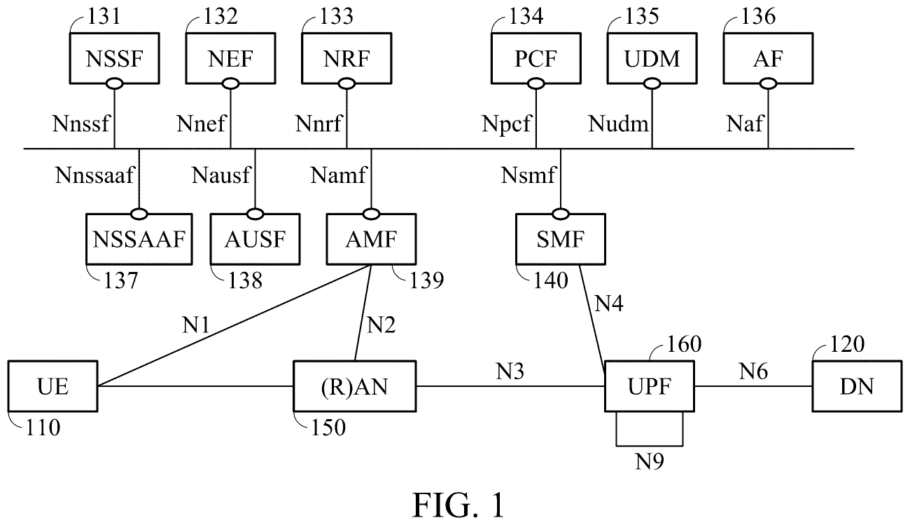

FIG. 1 is a schematic diagram of a network architecture according to an embodiment of the present disclosure. A 5G network architecture that is defined in a 3GPP specification and that is based on a service-oriented architecture in a non-roaming scenario is used as an example. The network architecture may include three parts: a terminal device part, a PLMN, and a data network (DN).

The terminal device part may include user equipment (UE) 110, and the UE 110 may also be referred to as terminal device. The UE 110 in the present disclosure is a device having a wireless transceiver function, and may communicate with one or more core network (CN) devices (which may also be referred to as core devices) via an access network device (which may also be referred to as an access device) in a radio access network (RAN) 150. The UE 110 may also be referred to as an access terminal, a terminal, a subscriber unit, a subscriber station, a mobile station, a remote station, a remote terminal, a mobile device, a user terminal, a user agent, a user apparatus, or the like. The UE 110 may be deployed on land, including an indoor device, an outdoor device, a handheld device, or a vehicle-mounted device; or may be deployed on water (such as a ship); or may be deployed in the air (for example, on aircraft, a balloon, or a satellite). The UE 110 may be a cellular phone, a cordless phone, a session initiation protocol (SIP) phone, a smart phone, a mobile phone, a wireless local loop (WLL) station, a personal digital assistant (PDA), or the like. Alternatively, the UE 110 may be a handheld device or a computing device that has a wireless communication function, another device connected to a wireless modem, a vehicle-mounted device, a wearable device, an unmanned aerial vehicle device, a terminal in the Internet of Things or Internet of Vehicles, a terminal in any form in a 5G network or a future network, relay user equipment, a terminal in a future evolved PLMN, or the like. The relay user equipment may be, for example, a 5G residential gateway (RG). For example, the UE 110 may be a virtual reality (VR) terminal, an augmented reality (AR) terminal, a wireless terminal in industrial control, a wireless terminal in self driving, a wireless terminal in telemedicine (remote medical), a wireless terminal in a smart grid, a wireless terminal in transportation safety, a wireless terminal in a smart city, a wireless terminal in a smart home, or the like. A type or the like of the UE is not limited in embodiments of the present disclosure.

The PLMN may include a network slice selection function (NSSF) 131, a network exposure function (NEF) 132, a network repository function (NRF) 133, a policy control function (PCF) 134, a unified data management (UDM) 135, an application function (AF) 136, a network slice-specific authentication and authorization function (NSSAAF) 137, an authentication server function (AUSF) 138, an access and mobility management function (AMF) 139, a session management function (SMF) 140, a user plane function (UPF) 160, a (radio) access network ((R)AN) 150, and the like. In the PLMN, a part other than the (R)AN 150 part may be referred to as a core network (CN) part.

A data network (DN) 120 may also be referred to as a packet data network (PDN), and is usually a network outside the PLMN, for example, a third-party network. For example, the PLMN may access a plurality of DNs 120, and a plurality of services may be deployed in the DNs 120, to provide services such as a data service and/or a voice service for the UE 110. The UE 110 may establish a connection to the PLMN through an interface (for example, an N1 interface in FIG. 1) provided by the PLMN, to use the services such as the data service and/or the voice service provided by the PLMN. The UE 110 may further access the data network DN 120 through the PLMN, to use an operator service deployed in the data network DN 120 and/or a service provided by a third party. The third party may be a service provider other than the PLMN and the UE 110, and may provide another service such as a data service and/or a voice service for the UE 110. A specific representation form of the third party may be specifically determined based on an actual application scenario and is not limited herein.

For example, the following briefly describes a network function in the PLMN.

The (R)AN 150 is a subnet of the PLMN, and is an implementation system between a service node (or the network function) in the PLMN and the UE 110. To access the PLMN, the UE 110 first passes through the (R)AN 150, and then is connected to the service node in the PLMN via the (R)AN 150. The access network device in embodiments of the present disclosure is a device that provides a wireless communication function for the terminal device 110, and may also be referred to as an access device, a (R)AN device, a network device, or the like. For example, the access device includes but is not limited to: a NG-RAN node, a next-generation base station (gNB) in a 5G system, an evolved NodeB (eNB) in an LTE system, a radio network controller (RNC), a NodeB (NB), a base station controller (BSC), a base transceiver station (BTS), a home base station (home evolved NodeB, or home NodeB, HNB), a baseband unit (BBU), a transmission reception point (TRP), a transmission point (TP), a small cell base station (pico), a mobile switching center, a network device in a future network, or the like. It may be understood that a specific type of the access network device is not limited in the present disclosure. In systems using different radio access technologies, devices with functions of the access network device may have different names.

Optionally, in some deployment of the access device, the access device may include a central unit (CU), a distributed unit (DU), and the like. In some other deployment of the access device, the CU may be further split into a CU-control plane (control plane, CP), a CU-user plane (user plane, UP), and the like. In still some other deployment of the access device, the access device may alternatively be in an open radio access network (ORAN) architecture or the like. A specific deployment manner of the access device is not limited in the present disclosure.

The NSSF 131 is responsible for determining a network slice instance, selecting the AMF 138, and the like.

The NEF 132 (which may also be referred to as an NEF network function or an NEF network functional entity) 132 is a control plane function provided by the operator. The NEF 132 securely exposes an external interface of the PLMN to a third party. When the SMF 140 needs to communicate with a third-party network function, the NEF 132 may serve as a relay for communication between the SMF 140 and the third-party network entity. When serving as the relay, the NEF 132 may translate identification information of a subscriber and identification information of the third-party network function. For example, when sending a subscription permanent identifier (SUPI) of the subscriber from the PLMN to the third party, the NEF 132 may translate the SUPI into an external identity (ID) corresponding to the SUPI. Conversely, when sending an external ID (an ID of a third-party network entity) to the PLMN, the NEF 132 may translate the external ID into an SUPI.

The NRF 133 may be configured to maintain real-time information of all network function services in a network.

The PCF 134 is a control plane function provided by the operator, and is configured to provide a protocol data unit (PDU) session policy for the SMF 140. The policy may include a charging-related policy, a QoS-related policy, an authorization-related policy, and the like.

The UDM 135 is a control plane function provided by the operator, and is responsible for storing information such as a subscription permanent identifier (SUPI), a security context, and subscription data of a subscriber in the PLMN. The subscriber in the PLMN may be specifically a subscriber using a service provided by the PLMN. For example, the SUPI of the subscriber may be a number of the terminal device SIM card. The security context may be a cookie, a token, or the like stored in a local terminal device (for example, a mobile phone). The subscription data of the subscriber may be a supporting service of the terminal device SIM card, for example, a traffic package of the mobile phone SIM card.

The AF 136 supports application influence on traffic routing, accessing a network exposure function, interacting with a policy framework for policy control, or the like.

The NSSAAF 137 is a network function that assists in completing slice authentication. In another implementation, the AUSF 138 or other NF can replace the NSSAAF 137 to assist in completing slice authentication.

The AUSF 138 is a control plane function provided by the operator, and is usually for primary authentication, to be specific, authentication between the UE 110 (the subscriber) and the PLMN.

The AMF 139 is a control plane network function provided by the PLMN, and is responsible for access control and mobility management when the UE 110 accesses the PLMN, for example, including functions such as mobility status management, allocation of a temporary user identity, and user authentication and authorization.

The SMF 140 is a control plane network function provided by the PLMN, and is responsible for managing a protocol data unit (PDU) session of the terminal device 110. The PDU session is a channel for transmitting a PDU, and the UE 110 and the DN 120 needs to transmit a PDU to each other through the PDU session. The SMF 140 may be responsible for establishment, maintenance, deletion, and the like of the PDU session. The SMF 140 includes session-related functions, for example, session management (for example, session establishment, modification, and release, including tunnel maintenance between the UPF 160 and the (R)AN 150, selection and control of the UPF 160, service and session continuity (SSC) mode selection, and roaming.

The UPF 160 is a gateway provided by the operator, and is a gateway for communication between the PLMN and the DN 120. The UPF 160 includes user plane-related functions, for example, data packet routing and transmission, packet detection, service usage reporting, Quality-of-Service (QoS) processing, lawful interception, uplink packet detection, and downlink data packet storage.

The network functions in the PLMN shown in FIG. 1 may further include a unified data repository (UDR) and the like. Another network function included in the PLMN is not limited in this embodiment of the present disclosure.

In FIG. 1, Nnssf, Nnssaaf, Nnef, Nausf, Nnrf, Npcf, Nudm, Naf, Namf, Nsmf, N1, N2, N3, N4, N6 and N9 are interface sequence numbers. For example, for meanings of the interface sequence numbers, refer to meanings defined in the 3GPP standard protocol. The meanings of the interface sequence numbers are not limited in the present disclosure. It should be noted that in FIG. 1, an example in which the terminal device is UE 110 is merely used for description. Names of interfaces between the network functions in FIG. 1 are also merely examples. During specific implementation, the names of the interfaces in the system architecture may be other names. This is not limited in the present disclosure.

The mobility management network function in the present disclosure may be the AMF 139 shown in FIG. 1, or may be another network function having the foregoing access and mobility management function AMF 139 in a future communication system. Alternatively, the mobility management network function in the present disclosure may be a mobility management entity (MME) or the like in an LTE system.

For ease of description, in embodiments of the present disclosure, the AMF 139 is referred to as an AMF for short, and the UE 110 is referred to as UE. In other words, in embodiments of the present disclosure, an AMF described below may be replaced with a mobility management network function, and UE described below may be replaced with user equipment. It may be understood that the replacement is also applicable to another network function that is not shown.

A service-oriented architecture and a universal interface are used for the network architecture (for example, a 5G network architecture) shown in FIG. 1. A conventional network element function is split into several self-contained, self-managed, and reusable network function service modules based on a network function virtualization (NFV) technology. The schematic diagram of the network architecture shown in FIG. 1 may be understood as a schematic diagram of the service-oriented 5G network architecture in the non-roaming scenario. In this architecture, different network functions are combined in an orderly manner based on requirements of a specific scenario, so that a capability and a service of a network may be customized, thereby avoiding deploying a dedicated physical network for different services. With network slicing technology, the operator may be capable of responding to customer requirements more flexibly and quickly and supporting flexible assignment of network resources.

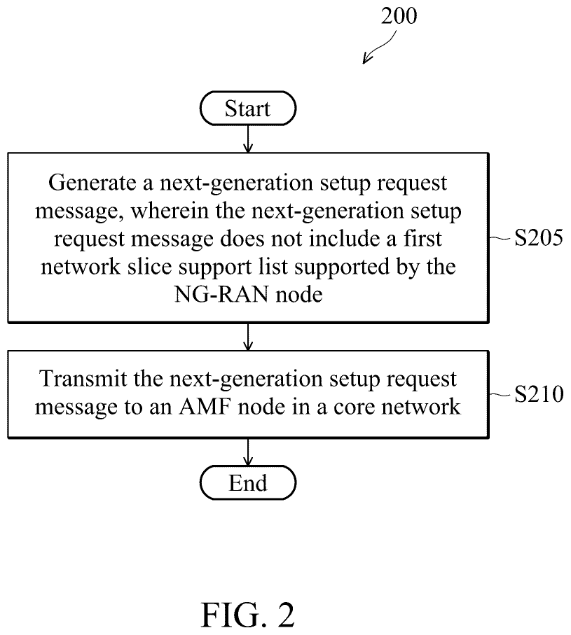

FIG. 2 is a flowchart showing a non-network-slicing-based configuration method 200 according to an embodiment of the present disclosure. Although this method is described as being executed by a NG-RAN node, this method may also be implemented by the (R)AN 150 in FIG. 1.

In step S205, a NG-RAN node generates a next-generation setup request (NG SETUP REQUEST) message, wherein the next-generation setup request message does not include a first network slice support list supported by the NG-RAN node. In one embodiment, the first network slice support list is a TAI slice support list.

In step S210, the NG-RAN node transmits the next-generation setup request message to an AMF node in a core network.

In an embodiment, after step S210, the NG-RAN node may receive a next-generation setup response (NG SETUP RESPONSE) message from the AMF node, wherein the next-generation setup response message does not include a second network slice support list supported by the core network. In one embodiment, the second network slice support list is a slice support list.

In another embodiment, the next-generation setup request message includes a Quality-of-Service (QoS) flow setup request list supported by the NG-RAN node. The next-generation setup response message includes a QoS flow for each transport network layer (TNL) information item of the application services required by the AMF node.

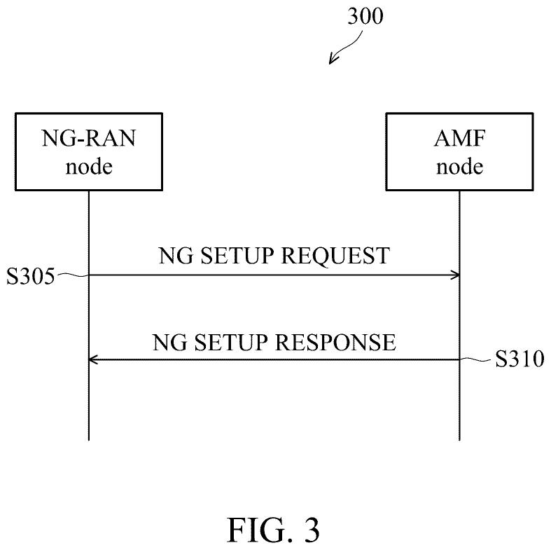

FIG. 3 is a schematic flowchart 300 of the next-generation setup procedure between the NG-RAN node and the AMF node according to an embodiment of the present disclosure.

In step S305, the NG-RAN node transmits the next-generation setup request (NG SETUP REQUEST) message to the AMF node in a core network.

In step S310, the NG-RAN node receives the next-generation setup response (NG SETUP RESPONSE) message transmitted by the AMF node.

In a possible implementation method modified according to 3GPP TS 38.413 shown below (see TABLE 1, TABLE 2, TABLE 3 and TABLE 4). TABLE 1 is the NG SETUP REQUEST message, and TABLE 2 is the NG SETUP RESPONSE message. As shown in TABLE 1 and TABLE 2, a first network slice support list supported by the NG-RAN node is not included in the NG SETUP REQUEST message, and a second network slice support list supported by the core network is not included in the NG SETUP RESPONSE message. When the UE subsequently attempts to establish a PDU session with the NG-RAN node, the NG-RAN node communicates QoS services with the core network through the INITIAL CONTEXT SETUP procedure of the existing architecture.

TABLE 1

| | | | IE type and | Semantics |
|---|---|---|---|---|
| IE/Group Name | Presence | Range | reference | description |
| Message Type | M | | 9.3.1.1 | |
| Global RAN | M | | 9.3.1.5 | |
| Node ID | | | | |
| RAN Node Name | O | | PrintableString | |
| | | | (SIZE(1 . . . | |
| | | | 150, . . . )) | |
| Supported TA List | | 1 | | Supported |
| | | | | TAs in the |
| | | | | NG-RAN |
| | | | | node. |
| >Supported TA | | 1 . . . <maxnoofTACs> | | |
| Item | | | | |
| >>TAC | M | | 9.3.3.10 | Broadcast |
| | | | | TAC |
| >>Broadcast | | 1 | | |
| PLMN List | | | | |
| >>>Broadcast | | 1 . . . <maxnoofBPLMNs> | | |
| PLMN Item | | | | |
| >>>>PLMN | M | | 9.3.3.5 | Broadcast |
| Identity | | | | PLMN |
| >>>>NPN | O | | 9.3.3.44 | If the NID IE |
| Support | | | | is included, it |
| | | | | identifies a |
| | | | | SNPN |
| | | | | together with |
| | | | | the PLMN |
| | | | | Identity IE. |
| >>Configured | O | | 9.3.3.50 | |
| TAC Indication | | | | |
| >>RAT | O | | 9.3.1.125 | RAT |
| Information | | | | information |
| | | | | associated |
| | | | | with the TAC |
| | | | | of the |
| | | | | indicated |
| | | | | PLMN(s). |
| Default Paging | M | | Paging DRX | |
| DRX | | | 9.3.1.90 | |
| UE Retention | O | | 9.3.1.117 | |
| Information | | | | |
| NB-IoT Default | O | | 9.3.1.137 | |
| Paging DRX | | | | |
| Extended RAN | O | | 9.3.1.193 | |
| Node Name | | | | |

TABLE 2

| | | | IE type and | Semantics |
|---|---|---|---|---|
| IE/Group Name | Presence | Range | reference | description |
| Message Type | M | | 9.3.1.1 | |
| AMF Name | M | | 9.3.3.21 | |
| Served GUAMI | | 1 | | |
| List | | | | |
| >Served | | 1 . . . <maxnoofServedGUAMIs> | | |
| GUAMI Item | | | | |
| >>GUAMI | M | | 9.3.3.3 | |
| >>Backup | O | | AMF Name | |
| AMF Name | | | 9.3.3.21 | |
| >>GUAMI | O | | ENUMERATED | |
| Type | | | (native, | |
| | | | mapped, . . . ) | |
| Relative AMF | M | | 9.3.1.32 | |
| Capacity | | | | |
| PLMN Support | | 1 | | |
| List | | | | |
| >PLMN | | 1 . . . <maxnoofPLMNs> | | |
| Support Item | | | | |
| >>PLMN | M | | 9.3.3.25 | |
| Identity | | | | |
| >>NPN | O | | 9.3.3.44 | If NID IE is |
| Support | | | | included, it |
| | | | | identifies a |
| | | | | SNPN |
| | | | | together with |
| | | | | the PLMN |
| | | | | Identity IE. |
| Criticality | O | | 9.3.1.3 | |
| Diagnostics | | | | |
| UE Retention | O | | 9.3.1.117 | |
| Information | | | | |
| IAB Supported | O | | ENUMERATED | Indication of |
| | | | (true, . . . ) | support for |
| | | | | IAB. |
| Extended AMF | O | | 9.3.3.51 | |
| Name | | | | |

In TABLE 1 and TABLE 2, information elements (IEs) marked as Mandatory (M) shall always be included in the message, and IEs marked as Optional (O) may or may not be included in the message.

TABLE 3 is the (NG SETUP REQUEST message, and TABLE 4 is the NG SETUP RESPONSE message. Different from TABLE 1 and TABLE 2, TABLE 3 and TABLE 4 also include information related to QoS flow setup. In other words, the NG-RAN node and the AMF in the core network may provide information related to QoS flow setup in the NG SETUP procedure, and there is no need to provide related information such as network slice support list.

TABLE 3

| | | | IE type and | Semantics |
|---|---|---|---|---|
| IE/Group Name | Presence | Range | reference | description |
| Message Type | M | | 9.3.1.1 | |
| Global RAN Node ID | M | | 9.3.1.5 | |
| RAN Node Name | O | | PrintableString | |
| | | | (SIZE(1 . . . | |
| | | | 150, . . . )) | |
| Supported TA List | | 1 | | Supported |
| | | | | TAs in the |
| | | | | NG-RAN |
| | | | | node. |
| >Supported TA | | 1 . . . <maxnoofTACs> | | |
| Item | | | | |
| >>TAC | M | | 9.3.3.10 | Broadcast |
| | | | | TAC |
| >>Broadcast | | 1 | | |
| PLMN List | | | | |
| >>>Broadcast | | 1 . . . <maxnoofBPLMNs> | | |
| PLMN Item | | | | |
| >>>>PLMN | M | | 9.3.3.5 | Broadcast |
| Identity | | | | PLMN |
| >>>>NPN | O | | 9.3.3.44 | If the NID IE |
| Support | | | | is included, it |
| | | | | identifies a |
| | | | | SNPN |
| | | | | together with |
| | | | | the PLMN |
| | | | | Identity IE. |
| >>Configured | O | | 9.3.3.50 | |
| TAC Indication | | | | |
| >>RAT | O | | 9.3.1.125 | RAT |
| Information | | | | information |
| | | | | associated |
| | | | | with the TAC |
| | | | | of the |
| | | | | indicated |
| | | | | PLMN(s). |
| QoS Flow Setup | | 1 | | |
| Request List | | | | |
| >QoS Flow Setup | | 1 . . . <maxnoofQoSFlows> | | |
| Request Item | | | | |
| >>QoS Flow | M | | 9.3.1.51 | |
| Identifier | | | | |
| >>QoS Flow Level | M | | 9.3.1.12 | |
| QoS Parameters | | | | |
| Default Paging DRX | M | | Paging DRX | |
| | | | 9.3.1.90 | |
| UE Retention | O | | 9.3.1.117 | |
| Information | | | | |
| NB-IoT Default Paging | O | | 9.3.1.137 | |
| DRX | | | | |
| Extended RAN Node | O | | 9.3.1.193 | |
| Name | | | | |

TABLE 4

| IE/Group | | | IE type and | Semantics |
|---|---|---|---|---|
| Name | Presence | Range | reference | description |
| Message | M | | 9.3.1.1 | |
| Type | | | | |
| AMF Name | M | | 9.3.3.21 | |
| Served | | 1 | | |
| GUAMI List | | | | |
| >Served | | 1 . . . <maxnoofServedGUAMIs> | | |
| GUAMI Item | | | | |
| >>GUAMI | M | | 9.3.3.3 | |
| >>Backup | O | | AMF Name | |
| AMF Name | | | 9.3.3.21 | |
| >>GUAMI | O | | ENU- | |
| Type | | | MERATED | |
| | | | (native, | |
| | | | mapped, . . . ) | |
| Relative AMF | M | | 9.3.1.32 | |
| Capacity | | | | |
| PLMN | | 1 | | |
| Support List | | | | |
| >PLMN | | 1 . . . <maxnoofPLMNs> | | |
| Support | | | | |
| Item | | | | |
| >>PLMN | M | | 9.3.3.25 | |
| Identity | | | | |
| >>NPN | O | | 9.3.3.44 | If NID IE is |
| Support | | | | included, it |
| | | | | identifies a |
| | | | | SNPN |
| | | | | together |
| | | | | with the |
| | | | | PLMN |
| | | | | Identity IE. |
| QoS Flow | | 1 . . . <maxnoofMulti- | | |
| per TNL | | ConnectivityMinusOne> | | |
| Information | | | | |
| Item | | | | |
| >QoS Flow | M | | 9.3.2.8 | |
| per TNL | | | | |
| Information | | | | |
| Criticality | O | | 9.3.1.3 | |
| Diagnostics | | | | |
| UE Retention | O | | 9.3.1.117 | |
| Information | | | | |
| IAB | C | | ENUMER- | Indication |
| Supported | | | ATED | of support |
| | | | (true, . . . ) | for IAB. |
| Extended | O | | 9.3.3.51 | |
| AMF Name | | | | |

In TABLE 3 and TABLE 4, information elements (IEs) marked as Mandatory (M) shall always be included in the message, and IEs marked as Optional (O) may or may not be included in the message.

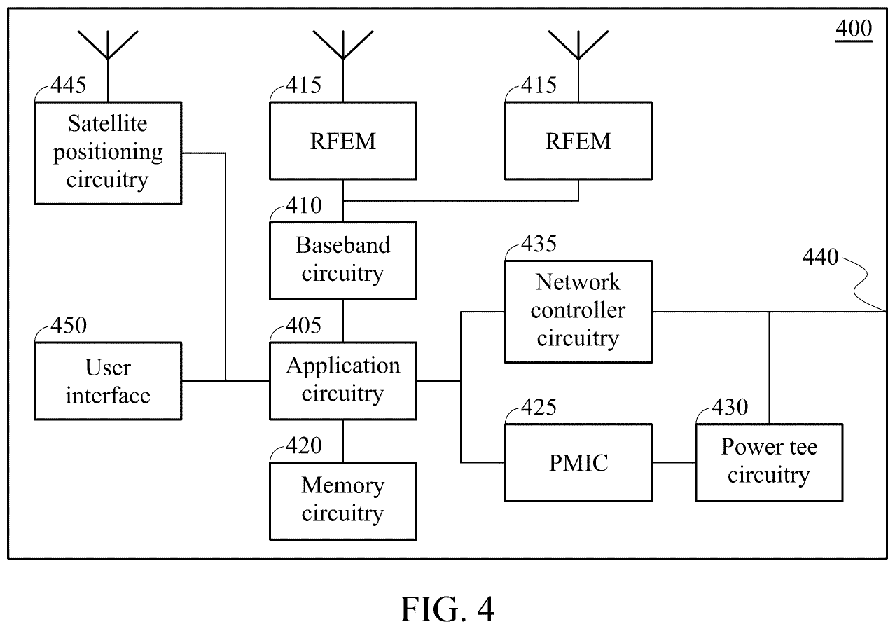

FIG. 4 illustrates an example of infrastructure equipment 400 in accordance with various embodiments of the present disclosure. The infrastructure equipment 400 (or “system 400”) may be implemented as a base station, RAN node such as the (R)AN node 150 and/or the NG-RAN node, and/or any other element/device discussed herein.

The system 400 includes application circuitry 405, baseband circuitry 410, one or more radio front-end modules (RFEMs) 415, memory circuitry 420, power management integrated circuitry (PMIC) 425, power tee circuitry 430, network controller circuitry 435, a network interface connector 440, satellite positioning circuitry 445, and a user interface 450. In some embodiments, the infrastructure equipment 400 may include additional elements such as, for example, memory/storage, display, camera, sensor, or input/output (I/O) interface.

The application circuitry 405 includes circuitry such as, but not limited to one or more processors (or processor cores), cache memory, and one or more of low drop-out voltage regulators (LDOs), interrupt controllers, serial interfaces such as SPI, I²C or universal programmable serial interface module, real time clock (RTC), timer-counters including interval and watchdog timers, general purpose input/output (I/O or IO), memory card controllers, Universal Serial Bus (USB) interfaces, Mobile Industry Processor Interface (MIPI) interfaces and Joint Test Access Group (JTAG) test access ports. The processors (or cores) of the application circuitry 405 may be coupled to (or may include) memory/storage elements and may be configured to execute instructions stored in the memory/storage elements to enable various applications or operating systems to run on the system 400. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processors of the application circuitry 405 may include, for example, one or more processor cores (CPUs), one or more application processors, one or more graphics processing units (GPUs), one or more reduced instruction set computing (RISC) processors, one or more complex instruction set computing (CISC) processors, one or more digital signal processors (DSP), one or more FPGAs, one or more PLDs, one or more ASICs, one or more microprocessors or controllers, or any suitable combination thereof. In some embodiments, the application circuitry 405 may comprise, or may be, a special-purpose processor/controller to operate according to the various embodiments herein.

In some implementations, the application circuitry 405 may include one or more hardware accelerators, which may be microprocessors, programmable processing devices, or the like. The one or more hardware accelerators may include, for example, computer vision (CV) and/or deep learning (DL) accelerators. As examples, the programmable processing devices may be one or more a field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such implementations, the circuitry of the application circuitry 405 may comprise logic blocks or logic fabric, and other interconnected resources that may be programmed to perform various functions, such as the procedures, methods, functions, etc. of the various embodiments discussed herein. In such embodiments, the circuitry of application circuitry 705 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up-tables (LUTs) and the like.

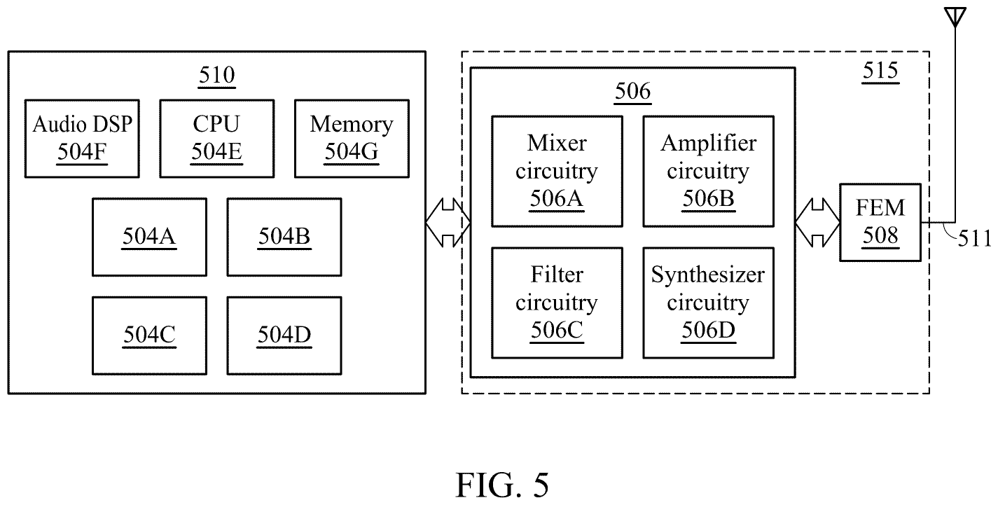

The baseband circuitry 410 may be implemented, for example, as a solder-down substrate including one or more integrated circuits, a single packaged integrated circuit soldered to a main circuit board or a multi-chip module containing two or more integrated circuits. The various hardware electronic elements of the baseband circuitry 410 are discussed with regard to FIG. 5.

The user interface circuitry 450 may include one or more user interfaces designed to enable user interaction with the system 400 or peripheral component interfaces designed to enable peripheral component interaction with the system 400. The user interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, an universal serial bus (USB) port, an audio jack, a power supply interface, etc.

The radio front-end modules (RFEMs) 415 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 511 of FIG. 5 infra), and the RFEM may be connected to multiple antennas. In alternative implementations, both mmWave and sub-mmWave radio functions may be implemented in the same physical RFEM 415, which incorporates both mmWave antennas and sub-mmWave.

The memory circuitry 420 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc.

The PMIC 425 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 430 may provide for electrical power drawn from a network cable to provide both power supply and data connectivity to the infrastructure equipment 400 using a single cable.

The network controller circuitry 435 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 400 via network interface connector 440 using a physical connection, which may be electrical (commonly referred to as a “copper interconnect”), optical, or wireless. The network controller circuitry 435 may include one or more dedicated processors and/or FPGAs to communicate using one or more of the aforementioned protocols. In some implementations, the network controller circuitry 435 may include multiple controllers to provide connectivity to other networks using the same or different protocols.

The satellite positioning circuitry 445 includes circuitry to receive and decode signals transmitted/broadcasted by a positioning network of a global navigation satellite system (GNSS). The satellite positioning circuitry 445 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the satellite positioning circuitry 445 may include a Micro-Technology for Positioning, Navigation, and Timing IC that uses a master timing clock to perform position tracking/estimation without GNSS assistance. The satellite positioning circuitry 445 may also be part of, or interact with, the baseband circuitry 410 and/or RFEMs 415 to communicate with the nodes and components of the positioning network. The satellite positioning circuitry 445 may also provide position data and/or time data to the application circuitry 405, which may use the data to synchronize operations with various infrastructure (e.g., the (R)AN nodes 150, etc.), or the like.

The components shown by FIG. 4 may communicate with one another using interface circuitry, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

FIG. 5 illustrates exemplary components of a baseband circuitry 510 and a radio front-end modules (RFEM) 515 in accordance with various embodiments of the present disclosure. The baseband circuitry 510 corresponds to the baseband circuitry 410 of FIG. 4. The RFEM 515 corresponds to the RFEM 415 of FIG. 4. As shown, the RFEMs 515 may include a Radio Frequency (RF) circuitry 506, a front-end module (FEM) circuitry 508, an antenna array 511 coupled together at least as shown.

The baseband circuitry 510 includes circuitry and/or control logic configured to carry out various radio/network protocol and radio control functions that enable communication with one or more radio networks via the RF circuitry 506. The radio control functions may include, but are not limited to, signal modulation/demodulation, encoding/decoding, radio frequency shifting, etc. In some embodiments, modulation/demodulation circuitry of the baseband circuitry 510 may include Fast-Fourier Transform (FFT), precoding, or constellation mapping/demapping functionality. In some embodiments, encoding/decoding circuitry of the baseband circuitry 510 may include convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments. The baseband circuitry 510 is configured to process baseband signals received from a receive signal path of the RF circuitry 506 and to generate baseband signals for a transmit signal path of the RF circuitry 506. The baseband circuitry 510 is configured to interface with the application circuitry 405 (see FIG. 4) for generation and processing of the baseband signals and for controlling operations of the RF circuitry 506. The baseband circuitry 510 may handle various radio control functions.

The aforementioned circuitry and/or control logic of the baseband circuitry 510 may include one or more single or multi-core processors. For example, the one or more processors may include a 3G baseband processor 504A, a 4G/LTE baseband processor 504B, a 5G/NR baseband processor 504C, or some other baseband processors 504D for other existing generations, generations in development or to be developed in the future (e.g., sixth generation (6G), etc.). In other embodiments, some or all of the functionality of the baseband processors 504A-D may be included in modules stored in the memory 504G and executed via a Central Processing Unit (CPU) 504E. In other embodiments, some or all of the functionality of the baseband processors 504A-D may be provided as hardware accelerators (e.g., FPGAs, ASICs, etc.) loaded with the appropriate bit streams or logic blocks stored in respective memory cells. In various embodiments, the memory 504G may store program code of a real-time OS (RTOS), which when executed by the CPU 504E (or other baseband processor), is to cause the CPU 504E (or other baseband processor) to manage resources of the baseband circuitry 510, schedule tasks, etc. In addition, the baseband circuitry 510 includes one or more audio digital signal processors (DSP) 504F. The audio DSPs 504F include elements for compression/decompression and echo cancellation and may include other suitable processing elements in other embodiments.

In some embodiments, each of the processors 504A-504E include respective memory interfaces to send/receive data to/from the memory 504G. The baseband circuitry 510 may further include one or more interfaces to communicatively couple to other circuitries/devices, such as an interface to send/receive data to/from memory external to the baseband circuitry 510; an application circuitry interface to send/receive data to/from the application circuitry 405 of FIG. 4); an RF circuitry interface to send/receive data to/from RF circuitry 506 of FIG. 5; a wireless hardware connectivity interface to send/receive data to/from one or more wireless hardware elements (e.g., Near Field Communication (NFC) components, Bluetooth Low Energy components, and/or the like); and a power management interface to send/receive power or control signals to/from the PMIC 425.

In alternate embodiments (which may be combined with the above described embodiments), the baseband circuitry 510 comprises one or more digital baseband systems, which are coupled with one another via an interconnect subsystem and to a CPU subsystem, an audio subsystem, and an interface subsystem. The digital baseband subsystems may also be coupled to a digital baseband interface and a mixed-signal baseband subsystem via another interconnect subsystem. Each of the interconnect subsystems may include a bus system, point-to-point connections, network-on-chip (NOC) structures, and/or some other suitable bus or interconnect technology, such as those discussed herein. The audio subsystem may include DSP circuitry, buffer memory, program memory, speech processing accelerator circuitry, data converter circuitry such as analog-to-digital and digital-to-analog converter circuitry, analog circuitry including one or more of amplifiers and filters, and/or other like components. In an aspect of the present disclosure, baseband circuitry 510 may include protocol processing circuitry with one or more instances of control circuitry (not shown) to provide control functions for the digital baseband circuitry and/or radio frequency circuitry (e.g., the radio front-end modules 515).

Although not shown by FIG. 5, in some embodiments, the baseband circuitry 510 includes individual processing devices to operate one or more wireless communication protocols (e.g., a “multi-protocol baseband processor” or “protocol processing circuitry”) and individual processing devices to implement PHY layer functions. In these embodiments, the PHY layer functions include the aforementioned radio control functions. In these embodiments, the protocol processing circuitry operates or implements various protocol layers/entities of one or more wireless communication protocols. In a first example, the protocol processing circuitry may operate LTE protocol entities and/or 5G/NR protocol entities when the baseband circuitry 510 and/or RF circuitry 506 are part of mmWave communication circuitry or some other suitable cellular communication circuitry. In the first example, the protocol processing circuitry would operate MAC, RLC, PDCP, SDAP, RRC, and NAS functions. In a second example, the protocol processing circuitry may operate one or more IEEE-based protocols when the baseband circuitry 510 and/or the RF circuitry 506 are part of a Wi-Fi communication system. In the second example, the protocol processing circuitry would operate Wi-Fi MAC and logical link control (LLC) functions. The protocol processing circuitry may include one or more memory structures (e.g., 504G) to store program code and data for operating the protocol functions, as well as one or more processing cores to execute the program code and perform various operations using the data. The baseband circuitry 510 may also support radio communications for more than one wireless protocol.

The various hardware elements of the baseband circuitry 510 discussed herein may be implemented, for example, as a solder-down substrate including one or more integrated circuits (ICs), a single packaged IC soldered to a main circuit board or a multi-chip module containing two or more ICs. In one example, the components of the baseband circuitry 510 may be suitably combined in a single chip or chipset, or disposed on the same circuit board. In another example, some or all of the constituent components of the baseband circuitry 510 and the RF circuitry 506 may be implemented together such as, for example, a system on a chip (SoC) or System-in-Package (SiP). In another example, some or all of the constituent components of the baseband circuitry 510 may be implemented as a separate SoC that is communicatively coupled with and the RF circuitry 506 (or multiple instances of the RF circuitry 506). In yet another example, some or all of the constituent components of the baseband circuitry 510 and the application circuitry 405 may be implemented together as individual SoCs mounted to the same circuit board (e.g., a “multi-chip package”).

In some embodiments, the baseband circuitry 510 may provide for communication compatible with one or more radio technologies. For example, in some embodiments, the baseband circuitry 510 may support communication with an E-UTRAN or other WMAN, a WLAN, a WPAN. Embodiments in which the baseband circuitry 510 is configured to support radio communications of more than one wireless protocol may be referred to as multi-mode baseband circuitry.

The RF circuitry 506 may enable communication with wireless networks using modulated electromagnetic radiation through a non-solid medium. In various embodiments, the RF circuitry 506 may include switches, filters, amplifiers, etc. to facilitate the communication with the wireless network. The RF circuitry 506 may include a receive signal path, which may include circuitry to down-convert RF signals received from the FEM circuitry 508 and provide baseband signals to the baseband circuitry 510. The RF circuitry 506 may also include a transmit signal path, which may include circuitry to up-convert baseband signals provided by the baseband circuitry 510 and provide RF output signals to the FEM circuitry 508 for transmission.

In some embodiments, the receive signal path of the RF circuitry 506 may include a mixer circuitry 506A, amplifier circuitry 506B and a filter circuitry 506C. In some embodiments, the transmit signal path of the RF circuitry 506 may include a filter circuitry 506C and a mixer circuitry 506A. The RF circuitry 506 may also include a synthesizer circuitry 506D for synthesizing a frequency for use by the mixer circuitry 506A of the receive signal path and the transmit signal path. In some embodiments, the mixer circuitry 506A of the receive signal path may be configured to down-convert RF signals received from the FEM circuitry 508 based on the synthesized frequency provided by synthesizer circuitry 506D. The amplifier circuitry 506B may be configured to amplify the down-converted signals and the filter circuitry 506C may be a low-pass filter (LPF) or band-pass filter (BPF) configured to remove unwanted signals from the down-converted signals to generate output baseband signals. Output baseband signals may be provided to the baseband circuitry 510 for further processing.

The FEM circuitry 508 may include a receive signal path, which may include circuitry configured to operate on RF signals received from antenna array 511, amplify the received signals and provide the amplified versions of the received signals to the RF circuitry 506 for further processing. FEM circuitry 508 may also include a transmit signal path, which may include circuitry configured to amplify signals for transmission provided by the RF circuitry 506 for transmission by one or more of antenna elements of antenna array 511. In various embodiments, the amplification through the transmit or receive signal paths may be done solely in the RF circuitry 506, solely in the FEM circuitry 508, or in both the RF circuitry 506 and the FEM circuitry 508.

The antenna array 511 comprises one or more antenna elements, each of which is configured to convert electrical signals into radio waves to travel through the air and to convert received radio waves into electrical signals. For example, digital baseband signals provided by the baseband circuitry 510 are converted into analog RF signals (e.g., modulated waveform) that will be amplified and transmitted via the antenna elements of the antenna array 511 including one or more antenna elements (not shown). The antenna elements may be omnidirectional, direction, or a combination thereof. The antenna elements may be formed in a multitude of arrangements as are known and/or discussed herein. The antenna array 511 may comprise microstrip antennas or printed antennas that are fabricated on the surface of one or more printed circuit boards. The antenna array 511 may be formed in as a patch of metal foil (e.g., a patch antenna) in a variety of shapes, and may be coupled to the RF circuitry 506 and/or the FEM circuitry 508 using metal transmission lines or the like.

Processors of the application circuitry 405 and processors of the baseband circuitry 510 may be used to execute elements of one or more instances of a protocol stack. For example, processors of the baseband circuitry 510, alone or in combination, may be used execute Layer 3, Layer 2, or Layer 1 functionality, while processors of the application circuitry 405 may utilize data (e.g., packet data) received from these layers and further execute Layer 4 functionality (e.g., TCP and UDP layers). As referred to herein, Layer 3 may comprise an RRC layer, Layer 2 may comprise a MAC layer, an RLC layer, and a PDCP layer, and Layer 1 may comprise a PHY layer of an UE/RAN node.

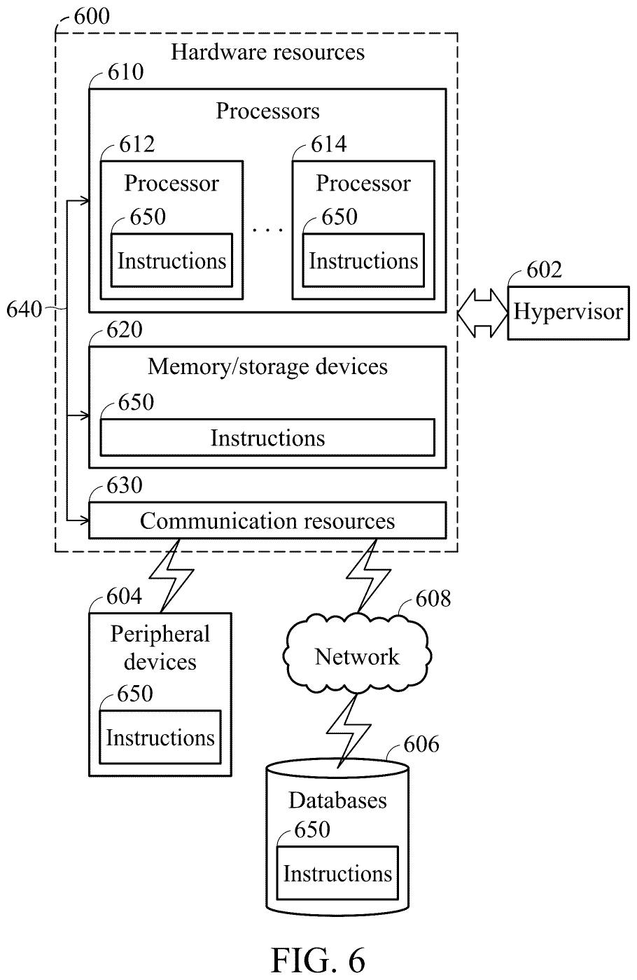

FIG. 6 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 6 shows a diagram representation of hardware resources 600 including one or more processors (or processor cores) 610, one or more memory/storage devices 620, and one or more communication resources 630, each of which may be communicatively coupled via a bus 640. For embodiments where node virtualization (e.g., NFV) is utilized, a hypervisor 602 may be executed to provide an execution environment for one or more network slices/sub-slices to utilize the hardware resources 600.

The processors 610 may include, for example, a processor 612 and a processor 614. The processors 610 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 620 may include main memory, disk storage, or any suitable combination thereof. The memory/storage devices 620 may include, but are not limited to, any type of volatile or nonvolatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 630 may include interconnection or network interface components or other suitable devices to communicate with one or more peripheral devices 604 or one or more databases 606 via a network 608. For example, the communication resources 630 may include wired communication components (e.g., for coupling via USB), cellular communication components, NFC components, Bluetooth (or Bluetooth Low Energy) components, Wi-Fi components, and other communication components.

The instructions 650 may comprise software, a program, an application, an applet, an app, or other executable code for causing at least any of the processors 610 to perform any one or more of the methodologies discussed herein. The instructions 650 may reside, completely or partially, within at least one of the processors 610 (e.g., within the processor's cache memory), the memory/storage devices 620, or any suitable combination thereof. Furthermore, any portion of the instructions 650 may be transferred to the hardware resources 600 from any combination of the peripheral devices 604 or the databases 606. Accordingly, the memory of processors 610, the memory/storage devices 620, the peripheral devices 604, and the databases 606 are examples of computer-readable and machine-readable media.

As mentioned above, in the non-network-slicing-based configuration method and device of the present disclosure, the RAN node does not need to configure information about the network slice, and the next-generation setup request message sent by the RAN node to the AMF node does not need to include a network slice support list. The RAN node and the AMF node may further communicate information related to QoS during the next-generation setup procedure to confirm whether the RAN node's capabilities are sufficient to provide the required applications. Therefore, the non-network-slicing-based configuration method and device disclosed in the present disclosure may increase flexibility in the deployment of RAN nodes and simplify the parameter settings of the RAN nodes and the communication process with the AMF node.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A non-network-slicing-based configuration method, comprising:
generating, by a next-generation radio access network (NG-RAN) node, a next-generation setup request message, wherein the next-generation setup request message does not include a first network slice support list supported by the NG-RAN node; and
transmitting, by the NG-RAN node, the next-generation setup request message to an access and mobility management function (AMF) node in a core network.

2. The non-network-slicing-based configuration method as claimed in claim 1,
wherein the next-generation setup request message includes a Quality-of-Service (QoS) flow setup request list supported by the NG-RAN node.

3. The non-network-slicing-based configuration method as claimed in claim 1, further comprising:
receiving, by the NG-RAN node, a next-generation setup response message from the AMF node, wherein the next-generation configuration response message does not include a second network slice support list supported by the core network.

4. The non-network-slicing-based configuration method as claimed in claim 3,
wherein the next-generation setup response message includes a Quality-of-Service (QoS) flow for each transport network layer (TNL) information item of application services required by the AMF node.

5. A non-network-slicing-based configuration device, comprising:
radio front-end circuitry, configured to perform wireless communication over a wireless network; and
processor circuitry, coupled to the radio front-end circuitry, configured to:
generate a next-generation setup request message, wherein the next-generation setup request message does not include a first network slice support list supported by the device; and
transmit, using the radio front end circuitry, the next-generation setup request message to an access and mobility management function (AMF) node in a core network.

6. The non-network-slicing-based configuration device as claimed in claim 5, wherein the next-generation setup request message includes a Quality-of-Service (QoS) flow setup request list supported by the non-network-slicing-based configuration device.

7. The non-network-slicing-based configuration device as claimed in claim 5, wherein the processor circuitry is further configured to:
receive a next-generation setup response message from the AMF node, wherein the next-generation configuration response message does not include a second network slice support list supported by the core network.

8. The non-network-slicing-based configuration device as claimed in claim 7, wherein the next-generation setup response message includes a Quality-of-Service (QoS) flow for each transport network layer (TNL) information item of application services required by the AMF node.

9. The non-network-slicing-based configuration device as claimed in claim 5, wherein the non-network-slicing-based configuration device is a next-generation radio access network (NG-RAN) node.

10. A non-transitory computer readable medium having instructions stored thereon that, when executed by one or more processors of a next-generation radio access network (NG-RAN) node, cause the NG-RAN node to perform operations, the operations comprising:
generating, by a next-generation radio access network (NG-RAN) node, a next-generation setup request message, wherein the next-generation setup request message does not include a first network slice support list supported by the NG-RAN node; and
transmitting, by the NG-RAN node, the next-generation setup request message to an access and mobility management function (AMF) node in a core network.

11. The non-transitory computer readable medium as claimed in claim 10, wherein the next-generation setup request message includes a Quality-of-Service (QoS) flow setup request list supported by the NG-RAN node.

12. The non-transitory computer readable medium as claimed in claim 10, wherein the operations further comprise:
receiving, by the NG-RAN node, a next-generation setup response message from the AMF node, wherein the next-generation configuration response message does not include a second network slice support list supported by the core network.

13. The non-transitory computer readable medium as claimed in claim 12, wherein the next-generation setup response message includes a Quality-of-Service (QoS) flow for each transport network layer (TNL) information item of application services required by the AMF node.
